(19) United States
(12) Patent Application Publication
(10) Pub. No.: US 2015/0293598 A1
(43) Pub. Date: Oct. 15, 2015

(54) METHOD FOR PROCESSING INFORMATION AND ELECTRONIC DEVICE

(71) Applicant: Lenovo (Beijing) Co., Ltd., Beijing (CN)

(72) Inventors: Guo Wang, Beijing (CN); Qian Zhao, Beijing (CN)

(73) Assignee: LENOVO (BEIJING) CO., LTD., Beijing (CN)

(21) Appl. No.: 14/554,812

(22) Filed: Nov. 26, 2014

(30) Foreign Application Priority Data
Apr. 15, 2014 (CN) 201410151848.4

(51) Int. Cl. G06F 3/01; G06K 9/52; G06F 3/03

(52) U.S. Cl. CPC G06F 3/017; G06F 3/0304; G06K 9/52

(57) ABSTRACT

A method for processing information and an electronic device is provided. The method is applied to a first electronic device having a first sensing unit. The method includes: detecting, by the first electronic device, a first operation of a user via the first sensing unit, and obtaining a first parameter characterizing the first operation; receiving a second parameter, characterizing the first operation, sent by a second electronic device, wherein the second parameter is obtained by a second sensing unit of the second electronic device detecting the first operation, wherein a detection dimension of the first operation detected by the first electronic device is different from that of the first operation detected by the second electronic device; determining and generating a first instruction based on the first parameter and the second parameter; and executing the first instruction.

This application claims priority to Chinese Patent Application No. 201410151848.4, entitled “INFORMATION PROCESSING METHOD, AND ELECTRONIC DEVICE”, filed with the Chinese Patent Office on Apr. 15, 2014, which is incorporated by reference in its entirety herein.

### TECHNICAL FIELD

The present application relates to computer technology, and particularly to a method for processing information and an electronic device.

### BACKGROUND

Along with the development of technology of wearable electronics, the wearable electronics such as smart glasses and smart bracelets have been widely used. At present, an electronic device can only analyze and use data obtained by a sensor provided thereon. Even if a user simultaneously uses multiple electronic devices such as a tablet, smart glasses, and a smart bracelet, one of the electronic devices can not use data obtained by the sensor of the other electronic devices. For example, a sensor of the tablet can locate a position of a user's finger in an X-axis and a Y-axis of a surface of a touch screen, but can not locate a position of the finger in a Z-axis. A sensor of the smart glasses worn by the user can obtain a distance between the user's finger and the touch screen, i.e., locate the position of the finger in the Z-axis. In practice, the tablet can not use the data obtained by the smart glasses, and thus can not supplement the data obtained by itself to achieve more functions.

### SUMMARY

In order to solve the technical problems in the existing technology, a method for processing information and an electronic device are provided according to embodiments of the application.

The method for processing information according to an embodiment of the application is applied to a first electronic device having a first sensing unit. The method includes:

detecting, by the first electronic device, a first operation of a user via the first sensing unit, and obtaining a first parameter characterizing the first operation;

receiving a second parameter, characterizing the first operation, sent by a second electronic device, wherein the second parameter is obtained by a second sensing unit of the second electronic device detecting the first operation, wherein a detection dimension of the first operation detected by the first electronic device is different from that of the first operation detected by the second electronic device;

determining and generating a first instruction based on the first parameter and the second parameter; and

executing the first instruction.

The first operation is a spatial gesture operation, the first sensing unit is a first image capturing unit, and a detection dimension of the first operation detected by the first electronic device indicates detection of the spatial gesture operation from a first angle by the first image capturing unit.

The first parameter is image information of an operator obtained from the first angle.

The first operation is a spatial gesture operation, the second sensing unit is a second image capturing unit, and a detection dimension of the first operation detected by the second electronic device indicates detection of the spatial gesture operation from a second angle by the second image capturing unit.

The second parameter is image information of an operator obtained from the second angle.

The first operation is a single finger rotation operation, the first sensing unit is a touch display unit, and a detection dimension of the first operation detected by the first electronic device indicates detection of a touch on the touch display unit by the touch display unit, the touch coming from the single finger rotation operation.

The first parameter is a position parameter of the touch.

The first operation is a single finger rotation operation, the second sensing unit is an acceleration sensing unit, and a detection dimension of the first operation detected by the second electronic device indicates detection of a rotation coming from the single finger rotation operation by the acceleration sensing unit.

The second parameter is an angle parameter of the rotation.

It is provided according to an embodiment of the application an electronic device. The electronic device is a first electronic device, and includes a first sensing unit and a processing unit, where

the first sensing unit is configured to receive a first operation;

the processing unit is configured to:
detect a first operation of a user via the first sensing unit and obtain a first parameter characterizing the first operation;
receive a second parameter, characterizing the first operation, sent by a second electronic device, wherein the second parameter is obtained by a second sensing unit of the second electronic device detecting the first operation, and wherein a detection dimension of the first operation detected by the first electronic device is different from that of the first operation detected by the second electronic device;
determine and generate a first instruction based on the first parameter and the second parameter; and
execute the first instruction.

The first operation is a spatial gesture operation, the first sensing unit is a first image capturing unit, and the detection dimension of the first operation detected by the first electronic device indicates detection of the spatial gesture operation from a first angle by the first image capturing unit.

The first parameter is image information of an operator obtained from the first angle.

The first operation is a spatial gesture operation, the second sensing unit is a second image capturing unit, and a detection dimension of the first operation detected by the second electronic device indicates detection of the spatial gesture operation from a second angle by the second image capturing unit.

The second parameter is image information of an operator obtained from the second angle.

The first operation is a single finger rotation operation, the first sensing unit is a touch display unit, and a detection dimension of the first operation detected by the first electronic device indicates detection of a touch on the touch display unit by the touch display unit, the touch coming from the single finger rotation operation.

The first parameter is a position parameter of the touch.

The first operation is a single finger rotation operation, the second sensing unit is an acceleration sensing unit, and a detection dimension of the first operation detected by the second electronic device indicates detection of a rotation coming from the single finger rotation operation by the acceleration sensing unit.

The second parameter is an angle parameter of the rotation.

### BRIEF DESCRIPTION OF THE DRAWINGS

For more clarity of description of technical solutions in embodiments of the application, drawings for accompanying the embodiments of the application are introduced below briefly. Apparently, the drawings described below are merely embodiments of the application. For those skilled in the art, other drawings may be obtained without paying any creative work according to the drawings provided.

FIG. 1 is a flow chart of an implementation of a first embodiment of a method for processing information provided in the application;

FIG. 2 is a diagram of an application scenario of a method for processing information according to an embodiment of the application;

FIG. 3 is a diagram of another application scenario of a method for processing information according to an embodiment of the application;

FIG. 4 is a diagram of a further application scenario of a method for processing information according to an embodiment of the application; and

FIG. 5 is a structural diagram of an embodiment of an electronic device according to an embodiment of the application.

### DESCRIPTION

In order to make objects, technical solutions, and advantages of the application clearer, the technical solutions according to embodiments of the application are clearly and completely described below in combination with the accompanying drawings.

Apparently, the described embodiments are merely a part instead of all embodiments of the application. Based on the embodiments of the application, any other embodiment obtained by those skilled in the art without creative work falls within the scope of the application. Except for cases in conflict, the embodiments of the application and features in the embodiments can be combined in any way. The steps as shown in the flow chart of the drawings can be executed in a computer system with a set of computer-executable instructions stored therein. Further, although a logical order is shown in the flow chart, in some cases the steps can be executed in a different order.

### First Embodiment

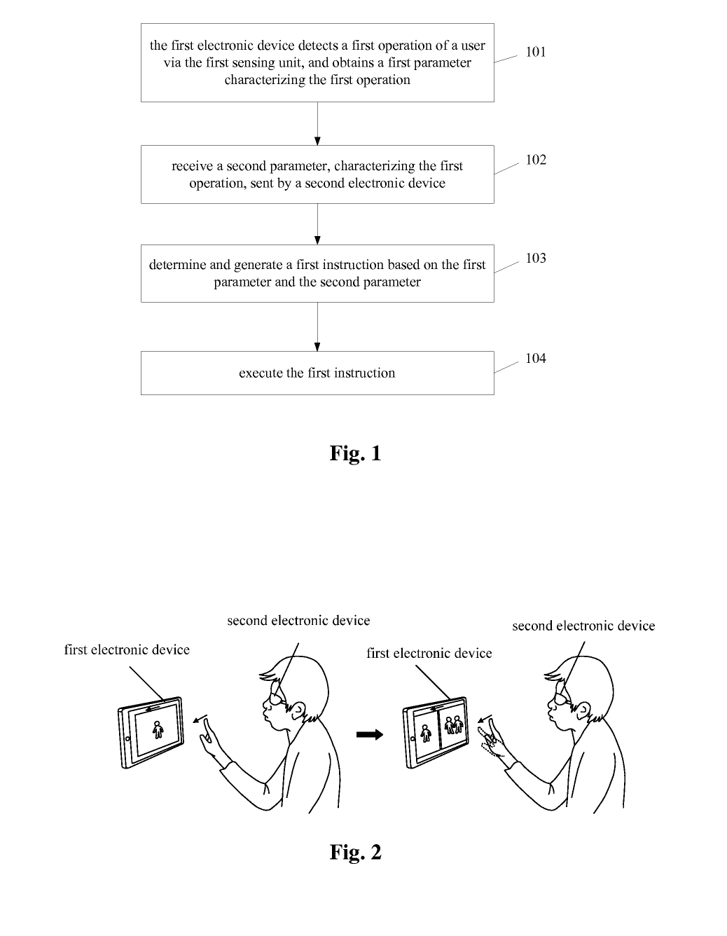

The first embodiment of the method for processing information provided in the application is applied to a first electronic device having a first sensing unit. As shown in FIG. 1, the method includes steps 101 to 104.

Step 101 includes: detecting, by the first electronic device, a first operation of a user via the first sensing unit, and obtaining a first parameter characterizing the first operation.

It should be noted that the first sensing unit may include an image capturing unit, a touch display unit, and an acceleration sensing unit.

It can be understood that the first operation may include a spatial gesture operation, and a single finger rotation operation.

Here, the first parameter may include image information of an operator, a position parameter of a touch, and an angle parameter of a rotation. In practice, the first parameter may also include a planar position parameter, a spatial position parameter, a displacement trace parameter, a pressure parameter, a speed parameter, and a temperature parameter.

Step 102 includes: receiving a second parameter, characterizing the first operation, sent by a second electronic device, where the second parameter is obtained by a second sensing unit of the second electronic device detecting the first operation.

A detection dimension of the first operation detected by the first electronic device is different from that of the first operation detected by the second electronic device.

It should be noted that the second sensing unit may include an image capturing unit, a touch display unit, and an acceleration sensing unit.

It can be understood that the first operation may include a spatial gesture operation, and a single finger rotation operation.

Here, the second parameter may include image information of an operator, a position parameter of a touch, and an angle parameter of a rotation. In practice, the second parameter may also include a planar position parameter, a spatial position parameter, a displacement trace parameter, a pressure parameter, a speed parameter, and a temperature parameter.

In applications, the first electronic device and the second electronic device are correlated in a preset range.

Step 103 includes: determining and generating a first instruction based on the first parameter and the second parameter.

An appropriate combination rule may be selected from preset combination rules according to types of the first parameter and the second parameter. The first parameter and the second parameter are combined according to the selected combination rule, and then the first instruction is determined.

Step 104 includes: executing the first instruction.

The first electronic device and the second electronic device may each include a tablet, smart glasses, a smart watch, and a smart bracelet.

Thus, in the first embodiment of the application, the first electronic device can use the data obtained by the second electronic device and then supplement the data obtained by the first electronic device to achieve more functions.

### Second Embodiment

The second embodiment of the method for processing information provided in the application is applied to a first electronic device having a first sensing unit. In this embodiment, the first electronic device is a tablet. The method includes steps 201 to 204.

Step 201 includes: detecting, by the first electronic device, a first operation of a user via the first sensing unit, and obtaining a first parameter characterizing the first operation.

In an embodiment, the first operation is a spatial gesture operation, the first sensing unit is a first image capturing unit, and a detection dimension of the first operation detected by the first electronic device indicates detection of the spatial gesture operation from a first angle by the first image capturing unit.

The first parameter is image information of an operator obtained from the first angle.

In an embodiment, the first operation is a single finger rotation operation, the first sensing unit is a touch display unit, and a detection dimension of the first operation detected by the first electronic device indicates detection of a touch on the touch display unit by the touch display unit, the touch coming from the single finger rotation operation.

The first parameter is a position parameter of the touch.

Step 202 includes: receiving a second parameter, characterizing the first operation, sent by a second electronic device, where the second parameter is obtained by a second sensing unit of the second electronic device detecting the first operation.

A detection dimension of the first operation detected by the first electronic device is different from that of the first operation detected by the second electronic device.

It should be noted that the second sensing unit may include an image capturing unit, a touch display unit, and an acceleration sensing unit.

It can be understood that the first operation may include a spatial gesture operation, and a single finger rotation operation.

Here, the second parameter may include image information of an operator, a position parameter of a touch, and an angle parameter of a rotation. In practice, the second parameter may also include a planar position parameter, a spatial position parameter, a displacement trace parameter, a pressure parameter, a speed parameter, and a temperature parameter.

Step 203 includes: determining and generating a first instruction based on the first parameter and the second parameter.

Step 204 includes: executing the first instruction.

Thus, in the embodiment, if the first operation is a spatial gesture operation, the detection dimension of the first operation detected by the first electronic device indicates detection of the spatial gesture operation from a first angle by the first image capturing unit to obtain image information of the operator. If the first operation is a single finger rotation operation, the detection dimension of the first operation detected by the first electronic device indicates detection of a touch on the touch display unit by the touch display unit to obtain a position parameter, the touch coming from the single finger rotation operation. Thus a more accurate first parameter characterizing the first operation is obtained.

### Third Embodiment

The third embodiment of the method for processing information provided in the application is applied to a first electronic device having a first sensing unit. In this embodiment, the second electronic device is smart glasses. The method includes steps 301 to 304.

Step 301 includes: detecting, by the first electronic device, a first operation of a user via the first sensing unit, and obtaining a first parameter characterizing the first operation.

It should be noted that the first sensing unit may include an image capturing unit, a touch display unit, and an acceleration sensing unit.

It can be understood that the first operation may include a spatial gesture operation, and a single finger rotation operation.

Here, the first parameter may include image information of an operator, a position parameter of a touch, and an angle parameter of a rotation. In practice, the first parameter may also include a planar position parameter, a spatial position parameter, a displacement trace parameter, a pressure parameter, a speed parameter, and a temperature parameter.

It can be understood that the first electronic device and the second electronic device are correlated in a preset range.

Step 302 includes: receiving a second parameter, characterizing the first operation, sent by a second electronic device, where the second parameter is obtained by a second sensing unit of the second electronic device detecting the first operation;

In an embodiment, the first operation is a spatial gesture operation, the second sensing unit is a second image capturing unit, and a detection dimension of the first operation detected by the second electronic device indicates detection of the spatial gesture operation from a second angle by the second image capturing unit.

The second parameter is image information of an operator obtained from the second angle.

In an embodiment, the first operation is a single finger rotation operation, the second sensing unit is an acceleration sensing unit, and the detection dimension of the first operation detected by the second electronic device indicates detection of a rotation of the single finger rotation operation by the acceleration sensing unit.

The second parameter is an angle parameter of the rotation.

A detection dimension of the first operation detected by the first electronic device is different from that of the first operation detected by the second electronic device.

Step 303 includes: determining and generating a first instruction based on the first parameter and the second parameter.

Here, an appropriate combination rule may be selected from preset combination rules according to types of the first parameter and the second parameter. The first parameter and the second parameter are combined according to the selected combination rule, and then the first instruction is determined.

Step 304 includes: executing the first instruction.

Thus, in the embodiment, if the first operation is a spatial gesture operation, the detection dimension of the first operation detected by the second electronic device indicates detection of the spatial gesture operation from the second angle by the second image capturing unit to obtain image information of the operator. If the first operation is a single finger rotation operation, the detection dimension of the first operation detected by the second electronic device indicates detection of the rotation of the single finger rotation operation by the acceleration sensing unit to obtain an angle parameter. Thus a more accurate second parameter characterizing the first operation is obtained.

### Fourth Embodiment

The fourth embodiment of the method for processing information provided in the application is applied to a first electronic device having a first sensing unit. In this embodiment, the first electronic device is a tablet, and the second electronic device is smart glasses. The method includes steps 401 to 404.

Step 401 includes: detecting, by the first electronic device, a first operation of a user via the first sensing unit, and obtaining a first parameter characterizing the first operation.

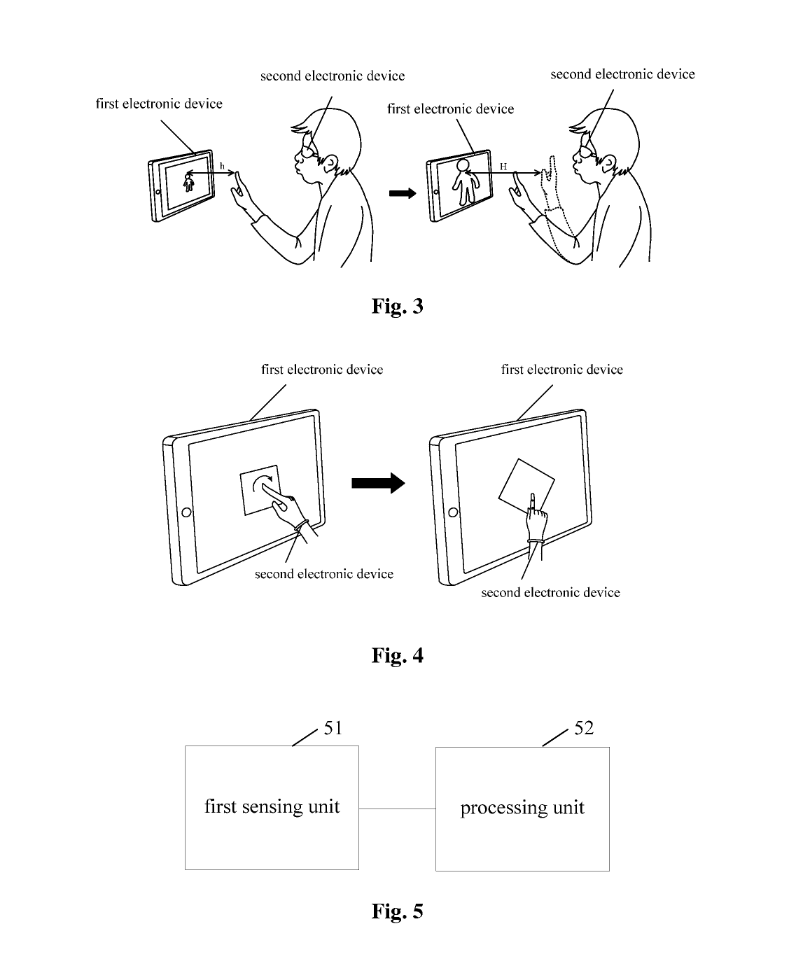

As shown in FIG. 2 and FIG. 3, the first operation is a spatial gesture operation, the first sensing unit is a first image capturing unit, and a detection dimension of the first operation detected by the first electronic device indicates detection of the spatial gesture operation from a first angle by the first image capturing unit.

The first parameter is image information of an operator obtained from the first angle.

Step 402 includes: receiving a second parameter, characterizing the first operation, sent by a second electronic device, where the second parameter is obtained by a second sensing unit of the second electronic device detecting the first operation.

As shown in FIG. 2 and FIG. 3, the first operation is a spatial gesture operation, the second sensing unit is a second image capturing unit, and a detection dimension of the first operation detected by the second electronic device indicates detection of the spatial gesture operation from a second angle by the second image capturing unit.

The second parameter is image information of an operator obtained from the second angle.

A detection dimension of the first operation detected by the first electronic device is different from that of the first operation detected by the second electronic device.

Step 403 includes: determining and generating a first instruction based on the first parameter and the second parameter.

Step 404 includes: executing the first instruction.

Thus, in the embodiment, the first electronic device determines and generates the first instruction according to the image information of the operator obtained from the first angle and the image information of the operator obtained from the second angle by the second electronic device. Therefore, the first operation is recognized more accurately, and the desired operation can be accurately executed by the first electronic device.

### Fifth Embodiment

The fifth embodiment of the method for processing information provided in the application is applied to a first electronic device having a first sensing unit. In this embodiment, the first electronic device is a tablet, and the second electronic device is a smart watch or a smart bracelet. The method includes steps 501 to 504.

Step 501 includes: detecting, by the first electronic device, a first operation of a user via the first sensing unit, and obtaining a first parameter characterizing the first operation.

As shown in FIG. 4, the first operation is a single finger rotation operation, the first sensing unit is a touch display unit, and a detection dimension of the first operation detected by the first electronic device indicates detection of a touch on the touch display unit by the touch display unit, the touch coming from the single finger rotation operation.

The first parameter is a position parameter of the touch.

Step 502 includes: receiving a second parameter, characterizing the first operation, sent by a second electronic device, where the second parameter is obtained by a second sensing unit of the second electronic device detecting the first operation.

As shown in FIG. 4, the first operation is a single finger rotation operation, the second sensing unit is an acceleration sensing unit, a detection dimension of the first operation detected by the second electronic device indicates detection of a rotation by the acceleration sensing unit, the rotation coming from the single finger rotation operation.

The second parameter is an angle parameter of the rotation.

A detection dimension of the first operation detected by the first electronic device is different from that of the first operation detected by the second electronic device.

Step 503 includes: determining and generating a first instruction based on the first parameter and the second parameter.

Step 504 includes: executing the first instruction.

Thus, in the embodiment, the first electronic device determines and generates the first instruction according to the position information of the touch and the angle parameter of the rotation obtained by the second electronic device. Therefore, the first operation is recognized more accurately, and the desired operation can be accurately executed by the first electronic device.

As shown in FIG. 5, an embodiment of an electronic device is provided in the application. The electronic device is referred to as a first electronic device, which includes: a first sensing unit 51 configured to receive a first operation, and a processing unit 52.

The processing unit 52 is configured to:

detect a first operation of a user via the first sensing unit, and obtain a first parameter characterizing the first operation;

receive a second parameter, characterizing the first operation, sent by a second electronic device, where the second parameter is obtained by a second sensing unit of the second electronic device detecting the first operation, where a detection dimension of the first operation detected by the first electronic device is different from that of the first operation detected by the second electronic device;

determine and generate a first instruction based on the first parameter and the second parameter; and

execute the first instruction.

In the embodiment, the first electronic device can use the data obtained by the second electronic device and then supplement the data obtained by the first electronic device to achieve more functions.

In an embodiment, the processing unit 52 selects an appropriate combination rule from preset combination rules according to types of the first parameter and the second parameter, combines the first parameter and the second parameter according to the selected combination rule, and then determines the first instruction.

It should be noted that the first sensing unit may include an image capturing unit, a touch display unit, and an acceleration sensing unit.

It can be understood that the first operation may include a spatial gesture operation, and a single finger rotation operation.

Here, the first parameter may include image information of an operator, a position parameter of a touch, and an angle parameter of a rotation. In practice, the first parameter may also include a planar position parameter, a spatial position parameter, a displacement trace parameter, a pressure parameter, a speed parameter, and a temperature parameter.

In addition, it should be noted that the second sensing unit may include an image capturing unit, a touch display unit, and an acceleration sensing unit.

It can be understood that the first operation may include a spatial gesture operation, and a single finger rotation operation.

Here, the second parameter may include image information of an operator, a position parameter of a touch, and an angle parameter of a rotation. In practice, the second parameter may also include a planar position parameter, a spatial position parameter, a displacement trace parameter, a pressure parameter, a speed parameter, and a temperature parameter.

It can be understood that the first electronic device and the second electronic device are correlated in a preset range.

In practice, the first electronic device and the second electronic device may each include a tablet, smart glasses, a smart watch, and a smart bracelet.

In an embodiment, the first operation is a spatial gesture operation, the first sensing unit is a first image capturing unit, and the detection dimension of the first operation detected by the first electronic device indicates detection of the spatial gesture operation from a first angle by the first image capturing unit.

The first parameter is image information of an operator obtained from the first angle.

Thus, in the embodiment, if the first operation is a spatial gesture operation, the detection dimension of the first operation detected by the first electronic device indicates detection of the spatial gesture operation from a first angle by the first image capturing unit to obtain image information of the operator. Thus a more accurate first parameter characterizing the first operation is obtained

In an embodiment, the first operation is a spatial gesture operation, the second sensing unit is a second image capturing unit, and the detection dimension of the first operation detected by the second electronic device indicates detection of the spatial gesture operation from a second angle by the second image capturing unit.

The second parameter is image information of an operator obtained from the second angle.

Thus, in the embodiment, if the first operation is a spatial gesture operation, the detection dimension of the first operation detected by the second electronic device indicates detection of the spatial gesture operation from a second angle by the second image capturing unit to obtain image information of the operator. Thus a more accurate second parameter characterizing the first operation is obtained.

In an embodiment, the first operation is a single finger rotation operation, the first sensing unit is a touch display unit, and the detection dimension of the first operation detected by the first electronic device indicates detection of a touch on the touch display unit by the touch display unit, the touch coming from the single finger rotation operation.

The first parameter is a position parameter of the touch.

Thus, in the embodiment, if the first operation is a single finger rotation operation, the detection dimension of the first operation detected by the first electronic device indicates detection of a touch on the touch display unit by the touch display unit to obtain a position parameter, the touch coming from the single finger rotation operation. Thus a more accurate first parameter characterizing the first operation is obtained.

In an embodiment, the first operation is a single finger rotation operation, the second sensing unit is an acceleration sensing unit, and the detection dimension of the first operation detected by the second electronic device indicates detection of a rotation by the acceleration sensing unit, the rotation coming from the single finger rotation operation.

The second parameter is an angle parameter of the rotation.

Thus, in the embodiment, if the first operation is a single finger rotation operation, the detection dimension of the first operation detected by the second electronic device indicates detection of the rotation by acceleration sensing unit to obtain an angle parameter, the rotation coming from the single finger rotation operation. Thus a more accurate second parameter characterizing the first operation is obtained.

The processing unit 52 may be implemented by a Central Processing Unit (CPU), a Digital Signal Processor (DSP), or a Field-Programmable Gate Array (FPGA).

Compared with the existing technology, in the technical solutions according to the embodiments of the application, the first electronic device can use the data obtained by the second electronic device and then supplement the data obtained by the first electronic device to achieve more functions.

It should be understood that in the embodiments of the application, the devices and the methods may be implemented in other ways. The device embodiments are merely illustrative. For example, the units are merely divided logically or functionally. There may be other ways of division in practice. For example, a plurality of units or components may be combined or integrated into another system, or a few features may be omitted or not executed. In addition, coupling, direct coupling, or communication connection between the components as shown or discussed may be implemented through interfaces, and indirect coupling or communication connection between devices or between units may be electrical, mechanical, or in other forms.

The units described above as separated components may be or may be not physically separated. The components shown as units may be or may be not physical units. The units may be located at a same place, or may be distributed on a plurality of network elements. A few or all of the units may be selected in practice to achieve the object of the solutions in the embodiments.

In addition, the functional units in the embodiments of the application may all be integrated in a processing unit, or may be separated as individual units. Or, two or more of the units are integrated in a unit. The integrated unit may be implemented in a form of hardware, or may be implemented in a form of software.

Those skilled in the art can understand that: a part or all of the steps in the method embodiments above may be implemented by hardware related to program instructions. The program may be stored in a computer readable medium. Steps including the steps in the foregoing method embodiments are performed when the program is executed. The aforementioned storage media include media where program code can be stored, such as a removable storage device, a Read-Only Memory (ROM), a Random Access Memory (RAM), a disk, or a CD.

Or, if the integrated units are implemented in a form of software functional modules and sold or used as a separated product, the integrated units may be stored in a computer readable storage medium. Based on such understanding, an essential part, i.e., a part that contributes to existing technology, of the technical solutions in the embodiments of the application may be presented in a form of a software product. The software product is stored in a storage medium and includes instructions to enable a computing device (may be a personal computer, a server, or a network device) to execute all or part of steps of the method embodiments of the application. The aforementioned storage media include media where program code can be stored, such as a removable storage device, a Read-Only Memory (ROM), a Random Access Memory (RAM), a disk, or a CD.

The described above are merely particular embodiments of the application. However, a scope of the application is not limited to the particular embodiments. Any modification or substitution within the technical scope disclosed in the application and obvious to those skilled in the art falls within the scope of the application. Therefore, the protection scope of the application shall be as the scope defined in the appended claims.

1. A method for processing information, applied to a first electronic device having a first sensing unit, comprising:
detecting, by the first electronic device, a first operation of a user via the first sensing unit, and obtaining a first parameter characterizing the first operation;
receiving a second parameter, characterizing the first operation, sent by a second electronic device, wherein the second parameter is obtained by a second sensing unit of the second electronic device detecting the first operation, wherein a detection dimension of the first operation detected by the first electronic device is different from that of the first operation detected by the second electronic device;
determining and generating a first instruction based on the first parameter and the second parameter; and
executing the first instruction.

2. The method according to claim 1, wherein the first operation is a spatial gesture operation, the first sensing unit is a first image capturing unit, and a detection dimension of the first operation detected by the first electronic device indicates detection of the spatial gesture operation from a first angle by the first image capturing unit.

3. The method according to claim 2, wherein the first parameter is image information of an operator obtained from the first angle.

4. The method according to claim 1, wherein the first operation is a spatial gesture operation, the second sensing unit is a second image capturing unit, and a detection dimension of the first operation detected by the second electronic device indicates detection of the spatial gesture operation from a second angle by the second image capturing unit.

5. The method according to claim 4, wherein the second parameter is image information of an operator obtained from the second angle.

6. The method according to claim 1, wherein the first operation is a single finger rotation operation, the first sensing unit is a touch display unit, and a detection dimension of the first operation detected by the first electronic device indicates detection of a touch on the touch display unit by the touch display unit, the touch coming from the single finger rotation operation.

7. The method according to claim 6, wherein the first parameter is a position parameter of the touch.

8. The method according to claim 1, wherein the first operation is a single finger rotation operation, the second sensing unit is an acceleration sensing unit, and a detection dimension of the first operation detected by the second electronic device indicates detection of a rotation coming from the single finger rotation operation by the acceleration sensing unit.

9. The method according to claim 8, wherein the second parameter is an angle parameter of the rotation.

10. An electronic device, comprising a first sensing unit and a processing unit, wherein the electronic device is a first electronic device,
the first sensing unit is configured to receive a first operation;
the processing unit is configured to:
detect a first operation of a user via the first sensing unit and obtain a first parameter characterizing the first operation;
receive a second parameter, characterizing the first operation, sent by a second electronic device, wherein the second parameter is obtained by a second sensing unit of the second electronic device detecting the first operation, and wherein a detection dimension of the first operation detected by the first electronic device is different from that of the first operation detected by the second electronic device;
determine and generate a first instruction based on the first parameter and the second parameter; and
execute the first instruction.

11. The electronic device according to claim 10, wherein the first operation is a spatial gesture operation, the first sensing unit is a first image capturing unit, and the detection dimension of the first operation detected by the first electronic device indicates detection of the spatial gesture operation from a first angle by the first image capturing unit.

12. The electronic device according to claim 11, wherein the first parameter is image information of an operator obtained from the first angle.

13. The electronic device according to claim 10, wherein the first operation is a spatial gesture operation, the second sensing unit is a second image capturing unit, and a detection dimension of the first operation detected by the second electronic device indicates detection of the spatial gesture operation from a second angle by the second image capturing unit.

14. The electronic device according to claim 13, wherein the second parameter is image information of an operator obtained from the second angle.

15. The electronic device according to claim 10, wherein the first operation is a single finger rotation operation, the first sensing unit is a touch display unit, and a detection dimension of the first operation detected by the first electronic device indicates detection of a touch on the touch display unit by the touch display unit, the touch coming from the single finger rotation operation.

16. The electronic device according to claim 15, wherein the first parameter is a position parameter of the touch.

17. The electronic device according to claim 10, wherein the first operation is a single finger rotation operation, the second sensing unit is an acceleration sensing unit, and a detection dimension of the first operation detected by the second electronic device indicates detection of a rotation coming from the single finger rotation operation by the acceleration sensing unit.

18. The electronic device according to claim 17, wherein the second parameter is an angle parameter of the rotation.
